(19) United States
(12) Patent Application Publication
(10) Pub. No.: US 2019/0250316 A1
(43) Pub. Date: Aug. 15, 2019

(54) OPTICAL FILTER

(71) Applicant: Daishinku Corporation, Kakogawa-shi (JP)

(72) Inventors: Manabu OHNISHI, Kakogawa-shi (JP); Hideshi SAITOH, Kakogawa-shi (JP); Yuki FUJII, Kakogawa-shi (JP); Yuichi KAMO, Kakogawa-shi (JP); Tatsuya SHOGAKI, Kakogawa-shi (JP)

(73) Assignee: Daishinku Corporation, Kakogawa-shi (JP)

(21) Appl. No.: 16/327,859

(22) PCT Filed: Aug. 29, 2017
(86) PCT No.: PCT/JP2017/030996

§ 371 Date: Feb. 25, 2019

(30) Foreign Application Priority Data
Aug. 31, 2016 (JP) 2016-169785

(51) Int. Cl. G02B 5/22; G02B 5/26; G02B 5/28

(52) U.S. Cl. CPC G02B 5/223; G02B 5/281; G02B 5/26

(57) ABSTRACT

To provide an optical filter which can sufficiently reduce transmission of the red component. The optical filter 10 includes a first filter 20, a second filter 30 formed on a first surface 20A of the first filter 20, and a third filter 40 formed on a second surface 20B of the first filter 20. The optical filter 10 has cutoff characteristics in a first band A1 defined from a long-wavelength side in the visible region to the near-infrared region and in a third band A3 defined on the long-wavelength side relative to the first band, and has transmission characteristics in a second band A2 defined between the first band A1 and the third band A3. In the first band A1, a cutoff band in which a transmittance is 5% or lower is set to a bandwidth of at least 100 nm.

### TECHNICAL FIELD

The present invention relates to an optical filter to be provided in an imaging device.

### BACKGROUND ART

One of the known optical filters to be provided in imaging devices has transmission characteristics in two wavelength bands in the visible region and the near-infrared region. Such an optical filter enables an imaging device to capture images not only under natural light in the daytime but also even under night vision in the nighttime or the like.

As an example of the above-mentioned optical filter, PTL 1 discloses an optical filter composed of an infrared-absorbing substrate (an infrared absorber) having near-infrared-ray-absorbing characteristics and a dielectric multilayer formed on the infrared-absorbing substrate. The infrared-absorbing substrate is made of an infrared-absorbing resin in which a transparent resin contains an infrared-absorbing compound.

### PRIOR ART DOCUMENT

### Patent Document

Patent Document 1: JP 5884953 B2

### SUMMARY OF INVENTION

### Problem to be Solved by the Invention

The optical filter disclosed in PTL 1 has cutoff characteristics in a first band (a ray-blocking band Za) provided in a near-infrared region and a third band (a ray-blocking band Zc) provided on the long-wavelength side relative to the first band, and has transmission characteristics in a second band (a ray-transmission band Zb) provided between the first band and the third band. In the optical filter disclosed in PTL 1, however, the cutoff characteristics in the first band are not sufficient in the near-infrared region and allow transmission of the red component. The transmitted red component results in color mixture, which deteriorates color reproducibility in an image taken by an imaging device.

An object of the present invention, made in view of the above problem, is to provide an optical filter which can sufficiently reduce transmission of the red component.

### Means for Solving the Problem

The present invention embodies a solution to the above-mentioned problem in the following manner. Namely, an aspect of the present invention relates to an optical filter having transmission characteristics in two wavelength bands in a visible region and a near-infrared region. This optical filter includes a first filter made of an infrared absorber, a second filter made of a dielectric multilayer and formed on a first surface of the first filter, and a third filter made of a dielectric multilayer and formed on a second surface of the first filter. The optical filter has cutoff characteristics in a first band defined from a long-wavelength side in the visible region to the near-infrared region and in a third band defined on the long-wavelength side relative to the first band, and has transmission characteristics in a second band defined between the first band and the third band. In the first band, a cutoff band in which a transmittance is 5% or lower is set to a bandwidth of at least 100 nm.

Owing to this configuration, the cutoff band in which the transmittance is 5% or lower in the first band of the optical filter is set to a bandwidth of at least 100 nm. The resulting optical filter ensures a wider cutoff band than conventional optical filters, and thereby ensures sufficient cutoff characteristics in the first band. As a result, the optical filter can sufficiently reduce transmission of the red component and can prevent color mixture caused by transmission of the red component. Eventually, the optical filter can prevent deterioration of color reproducibility of an image taken by an imaging device.

The optical filter having the above configuration may be further configured in the following manner. In the first filter, a wavelength at which a transmittance of the first filter reaches 50% may range from 640 nm to 660 nm in the visible region, and an absorption maximum is in a range from 650 nm to 800 nm. In the second filter, a wavelength at which a transmittance of the second filter reaches 50% may range from 685 nm to 710 nm, and the cutoff band in which the transmittance is 5% or lower may be provided in a range of at least 100 nm in the near-infrared region.

Owing to this configuration, the first filter made of an infrared absorber having the above characteristics can make the optical filter less dependent on the incident angle in the visible region, and the optical filter can inhibit appearance of a ghost or flare in an image taken by an imaging device.

In the optical filter having the above configuration, the wavelength at which the transmittance of the second filter reaches 50% may be on a long-wavelength side relative to the wavelength at which the transmittance of the first filter reaches 50% in the visible region.

Owing to this configuration, the half-power wavelength of the second filter (the wavelength at which the transmittance reaches 50%) is on the long-wavelength side relative to the half-power wavelength of the first filter in the visible region. Absorption of light by the first filter reduces the amount of light reflected by the second filter, and reduction of reflected light inhibits appearance of a ghost caused by reflection of light by the second filter.

In the optical filter having the above configuration, the first filter and the second filter may provide the first band, and the third filter may provide the third band. Alternatively, the first filter may provide the cutoff characteristics on a short-wavelength side in the first band, the second filter may provide the transmission characteristics on a short-wavelength side in the second band, and the third filter may provide the transmission characteristics on a long-wavelength side in the second band.

Owing to this configuration, the optical filter can easily change the bandwidth of the transmission band in which the transmittance is 50% or higher in the second band, and can flexibly meet various demands to its filter characteristics in the near-infrared region. The transmission band in the second band in which the transmittance reaches 50% can be set to a bandwidth of 35 nm to 200 nm. The transmission band in which the transmittance reaches 50% in the second band can be set in a range from 800 nm to 1000 nm.

In the optical filter having the above configuration, the first filter may be composed of a transparent substrate and an infrared absorption dye applied to the transparent substrate, and the third filter may be composed of an antireflective film. By adjusting the type, concentration, thickness or other conditions for the infrared absorption dye, this configuration can achieve desired infrared absorption characteristics more easily than in the case of using the infrared-absorbing resin substrate.

In the optical filter having the above configuration, the first filter and the second filter may provide the first band, and the second filter may provide the third band. Alternatively, the first filter alone, or a combination of the first filter and the second filter, may provide the cutoff characteristics on the short-wavelength side in the first band, and the second filter may provide not only the transmission characteristics on the short-wavelength side in the second band and but also the transmission characteristics on the long-wavelength side in the second band. Owing to these configurations, the second filter, which can provide the transmission characteristics in the second band by itself, can be formed on the surface opposite to the surface of the infrared absorption dye. Eventually, it is possible to prevent damage (particularly, thermal damage) to the infrared absorption dye during the filter formation.

In the optical filter having the above configuration, the bandwidth of the wavelength at which the transmittance in the first band reaches 50% may be greater than the bandwidth of the wavelength at which the transmittance of the first filter reaches 50% and the bandwidth of the wavelength at which the transmittance of the second filter reaches 50%.

Owing to this configuration, the transmission band (the second band) can be set in a desired range in the near-infrared region by means of the first and second filters. In the visible region, the optical filter can be made less dependent on the incident angle and can thereby inhibit appearance of a ghost or flare in an image taken by an imaging device.

In the optical filter having the above configuration, the second filter may include a plurality of high-refractive-index layers and a plurality of low-refractive-index layers alternately laminated on each other, the low-refractive-index layers having a smaller refractive index than the high-refractive-index layers. In the second filter, an average optical thickness of the low-refractive-index layers may be smaller than an average optical thickness of the high-refractive-index layers, and the thickness ratio of the average optical thickness of the low-refractive-index layers to the average optical thickness of the high-refractive-index layers may be from 0.50 to 0.85.

Owing to this configuration, the cutoff band that has cutoff characteristics derived from the second filter can be narrower, and the transmission band (the second band) can be set in a desired range in the near-infrared region, separately from the transmission band in the visible region.

### Effect of the Invention

The optical filter according to the present invention presents following advantageous effects. The cutoff band in which the transmittance is 5% or lower in the first band is set to a bandwidth of at least 100 nm. The resulting optical filter ensures a wider cutoff band than conventional optical filters, and thereby ensures sufficient cutoff characteristics in the first band. As a result, the optical filter can sufficiently reduce transmission of the red component and can prevent color mixture caused by transmission of the red component. Eventually, the optical filter can prevent deterioration of color reproducibility of an image taken by an imaging device.

### BRIEF DESCRIPTION OF DRAWINGS

FIG. 1 shows a brief configuration of an imaging device using an optical filter according to the present invention.

FIG. 2 schematically shows a brief configuration of the optical filter according to the present invention.

FIG. 3 shows an example of filter characteristics of the optical filter shown in FIG. 2.

FIG. 4 shows an example of filter characteristics of a first filter in the optical filter shown in FIG. 2.

FIG. 5 is a table relating to an example of constitutive layers for a second filter in the optical filter shown in FIG. 2.

FIG. 6 shows an example of filter characteristics of the second filter according to FIG. 5.

FIG. 7 is a table relating to an example of constitutive layers for a third filter in the optical filter shown in FIG. 2.

FIG. 8 shows an example of filter characteristics of the third filter according to FIG. 7.

FIG. 9 represents partial filter characteristics of the optical filter shown in FIG. 2 when incident angles of light are 0°, 10°, 20°, and 30°.

FIG. 10 schematically shows a brief configuration of an optical filter according to another embodiment of the present invention.

FIG. 11 shows an example of filter characteristics of the optical filter shown in FIG. 10.

FIG. 12 shows an example of filter characteristics of a first filter in the optical filter shown in FIG. 10.

FIG. 13 shows an example of filter characteristics of a second filter in the optical filter shown in FIG. 10.

FIG. 14 is a table relating to an example of constitutive layers for a third filter in the optical filter shown in FIG. 10.

FIG. 15 shows an example of filter characteristics of the third filter according to FIG. 14.

### MODE FOR CARRYING OUT THE INVENTION

Hereinafter, an optical filter according to an embodiment (First Embodiment) of the present invention is described with reference to the drawings. The optical filter according to this embodiment, to be provided in an imaging device, has transmission characteristics in two wavelength bands in the visible region and the near-infrared region. The wavelength band having transmission characteristics in the visible region and the wavelength band having transmission characteristics in the near-infrared region are separated from each other. In this embodiment, the visible region refers to wavelengths from about 400 nm to about 700 nm, and the near-infrared region refers to wavelengths from about 700 nm to about 1100 nm.

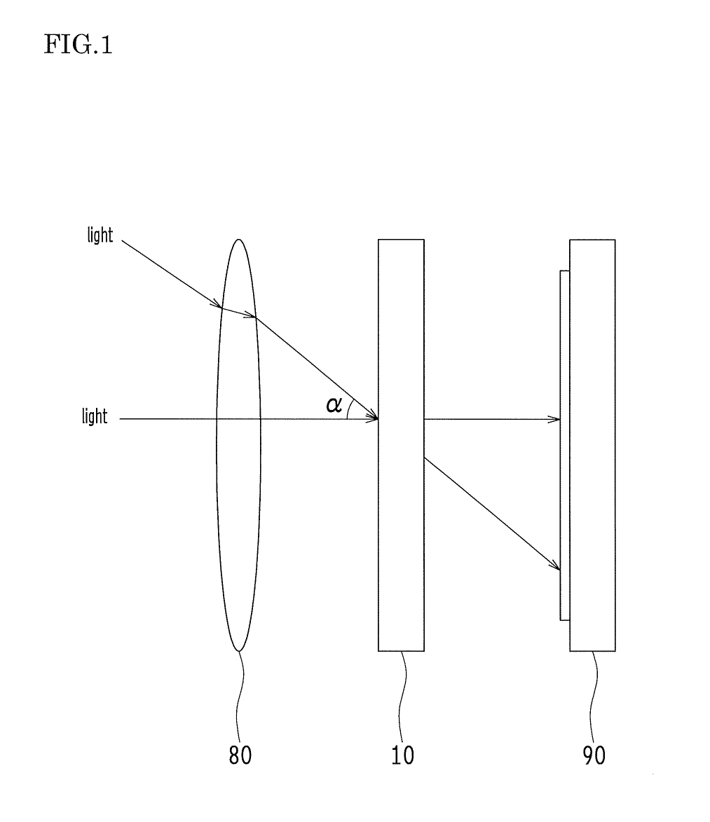

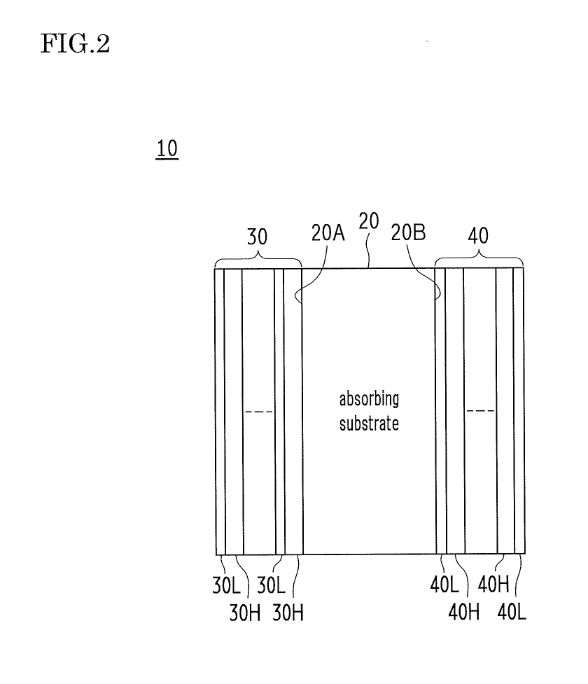

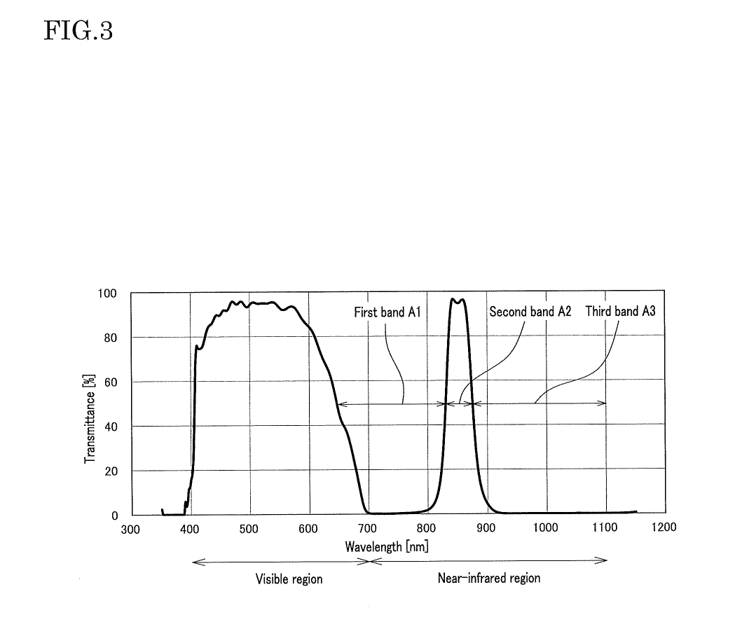

FIG. 1 shows a brief configuration of an imaging device using an optical filter 10. FIG. 2 schematically shows a brief configuration of the optical filter 10. FIG. 3 shows an example of filter characteristics of the optical filter 10.

As shown FIG. 1, an imaging device is equipped with an optical filter 10. When rays are collected by a lens 80, the optical filter 10 transmits rays in two wavelength bands in the visible region and the near-infrared region, and allows the transmitted rays to be incident on an imaging element 90 such as a CCD or a CMOS. FIG. 1 illustrates two cases: where rays are vertically incident on the lens 80; and where rays are obliquely incident on the lens 80 at an incident angle a.

As shown in FIG. 2, the optical filter 10 has a first filter 20 made of an infrared absorber, a second filter 30 made of a dielectric multilayer and applied to one surface of the first filter 20, and a third filter 40 made of a dielectric multilayer and applied to the other surface of the first filter 20. The optical filter 10 has filter characteristics (a waveform of transmittance) as shown in FIG. 3. The constituents of the optical filter 10 are detailed below.

### First Filter

The first filter 20 is made of an infrared-absorbing substrate (an infrared absorber) and has characteristics to absorb rays in the near-infrared region. In this embodiment, the infrared absorber for the first filter 20 is an infrared-absorbing resin in which a transparent resin contains an infrared-absorbing compound (a dye). The transparent resin and the dye may be known substances, for example, as disclosed in JP 5884953 B2.

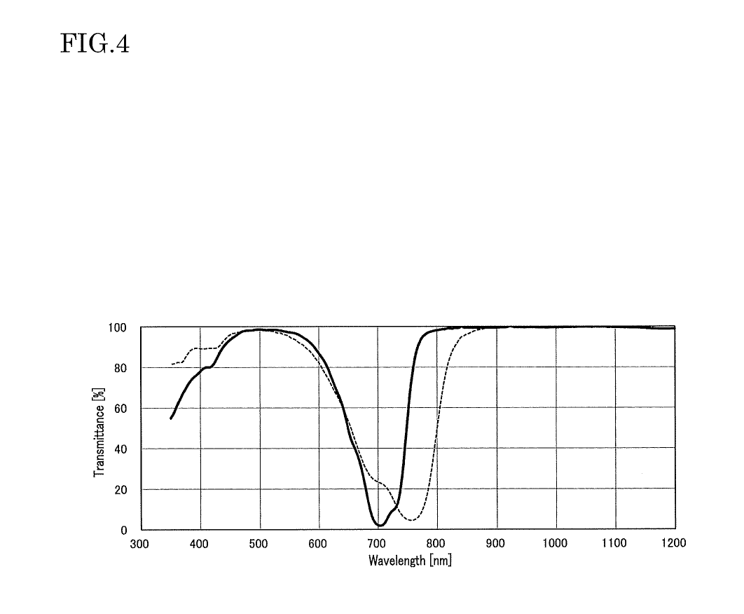

As shown in FIG. 4, the first filter 20 has an absorption maximum, where the transmittance is minimum, in the vicinity of the boundary between the visible region and the near-infrared region. FIG. 4 shows filter characteristics of the first filter 20 when the incident angle of light α (see FIG. 1) is 0° (when rays are vertically incident).

Specifically, the first filter 20 has transmission characteristics almost entirely in the visible region (400 nm to 700 nm), with the transmittance falling gently on the long-wavelength side (at wavelengths longer than 600 nm) in the visible region. In the visible region, the transmittance of the first filter 20 is 50% or higher in a wavelength band from the short-wavelength end in the visible region (400 nm) to about 650 nm, 80% or higher in a wavelength band from the short-wavelength end in the visible region (400 nm) to about 615 nm, 90% or higher in a wavelength band from about 440 nm to about 590 nm, and 95% or higher in a wavelength band from about 458 nm to about 570 nm.

The first filter 20 also has transmission characteristics almost entirely in the near-infrared region (700 nm to 1100 nm), with the transmittance rising on the short-wavelength side (at wavelengths shorter than 750 nm) in the near-infrared region. In the near-infrared region, the transmittance of the first filter 20 is 50% or higher in a wavelength band from about 750 nm to the long-wavelength end in the near-infrared region (1100 nm), 80% or higher in a wavelength band from about 760 nm to the long-wavelength end in the near-infrared region (1100 nm), 90% or higher in a wavelength band from about 770 nm to the long-wavelength end in the near-infrared region (1100 nm), and 95% or higher in a wavelength band from about 776 nm to the long-wavelength end in the near-infrared region (1100 nm). In the first filter 20, the rate of change (the rate of increase) in transmittance on the short-wavelength side in the near-infrared region is greater than the rate of change (the rate of decrease) in transmittance on the long-wavelength side in the visible region.

Further, the first filter 20 has following absorption characteristics in the vicinity of the boundary between the visible region and the near-infrared region. The transmittance of the first filter 20 is 20% or lower in a wavelength band from about 680 nm to about 740 nm, 10% or lower in a wavelength band from about 686 nm to about 728 nm, 5% or lower in a wavelength band from about 690 nm to about 716 nm, and is minimum (about 1.9%) at a wavelength of about 704 nm (absorption maximum). The absorption maximum of the first filter 20, which is at the wavelength of about 704 nm in this embodiment, simply needs to be in a range from 650 nm to 800 nm. As another example of the first filter 20, shown in broken line in FIG. 4, the absorption maximum of the first filter 20 may be, for example, at about 760 nm.

### Second Filter

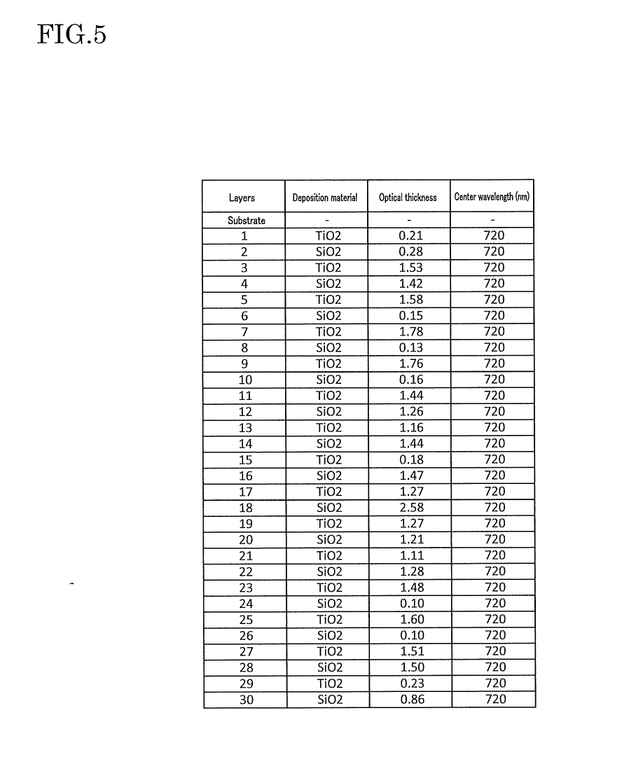

As shown in FIG. 2, the second filter 30 is made of a dielectric multilayer formed on a first surface 20A of the first filter 20. Specifically, as indicated in FIG. 5, the second filter 30 has an alternately laminated structure composed of high-refractive-index TiO₂ layers 30H and low-refractive-index SiO₂ layers 30L. The second filter 30 has a total of 30 layers including 15 high-refractive-index layers 30H and 15 low-refractive-index layers 30L. When counted from the first filter 20, the odd-numbered layers are the high-refractive-index layers 30H, and the even-numbered layers are the low-refractive-index layers 30L. This means that the first layer closest to the first filter 20 (the bottom layer) is a high-refractive-index layer 30H, and that the 30th layer closest to the atmosphere (the top layer) is a low-refractive-index layer 30L. The order of laminating the high-refractive-index layers 30H and the low-refractive-index layers 30L are not limited to this example. In another mode of this embodiment, when counted from the first filter 20, the odd-numbered layers may be the low-refractive-index layers 30L, and the even-numbered layers may be the high-refractive-index layers 30H. In yet another mode of this embodiment, the number of high-refractive-index layers 30H may be greater or smaller by one than the number of low-refractive-index layers 30L. For example, similar to the third filter 40 to be described later, the number of low-refractive-index layers 30L may be greater by one than that of high-refractive-index layers 30H.

The material for the high-refractive-index layers 30H is TiO₂ in this embodiment, but is not limited thereto, and may be ZrO₂, Nb₂O₅, or Ta₂O₅, for example. In other words, a material having a refractive index of greater than 2.0 is preferable for the high-refractive-index layers 30H. Similarly, the material for the low-refractive-index layers 30L is SiO₂ in this embodiment, but is not limited thereto, and may be MgF₂ or the like. In other words, a material having a smaller refractive index than the high-refractive-index layers 30H is preferable for the low-refractive-index layers 30L, and a material having a refractive index of less than 1.5 is more preferable.

The constitutive layers of the second filter 30 (the low-refractive-index layers 30L and the high-refractive-index layers 30H) are vapor deposited alternately by known vacuum deposition equipment. The thickness of vapor deposition is designed by the optical thickness Nd obtained as the product of the refractive index N and the physical thickness d. For example, the optical thickness of the second filter 30 is designed as indicated in FIG. 5. The optical thickness Nd and the center wavelength λ are related as [Nd=λ/4]. The center wavelength in FIG. 5 (720 nm) is the center wavelength for designing the film thickness.

As indicated in FIG. 5, the second filter 30 composed of the high-refractive-index layers 30H and the low-refractive-index layers 30L has a total of 30 layers and has a total film thickness (physical thickness) of about 3.1 μm. The second filter 30 preferably has 20 to 60 layers and preferably has a total film thickness of 2.0 μm to 6.0 μm.

In the second filter 30, the optical thickness of the low-refractive-index layers 30L is from 0.10 to 2.58, and the average optical thickness is 0.93. The optical thickness of the high-refractive-index layers 30H in the second filter 30 is from 0.18 to 1.78, and the average optical thickness is 1.21. Thus, in the second filter 30, the average optical thickness of the low-refractive-index layers 30L is less than that of the high-refractive-index layers 30H, and the thickness ratio of the average optical thickness of the low-refractive-index layers 30L to the average optical thickness of the high-refractive-index layers 30H [the average optical thickness of the low-refractive-index layers 30L/the average optical thickness of the high-refractive-index layers 30H] is 0.77. Preferably, the thickness ratio of the average optical thickness of the low-refractive-index layers 30L to the average optical thickness of the high-refractive-index layers 30H is from 0.50 to 0.85.

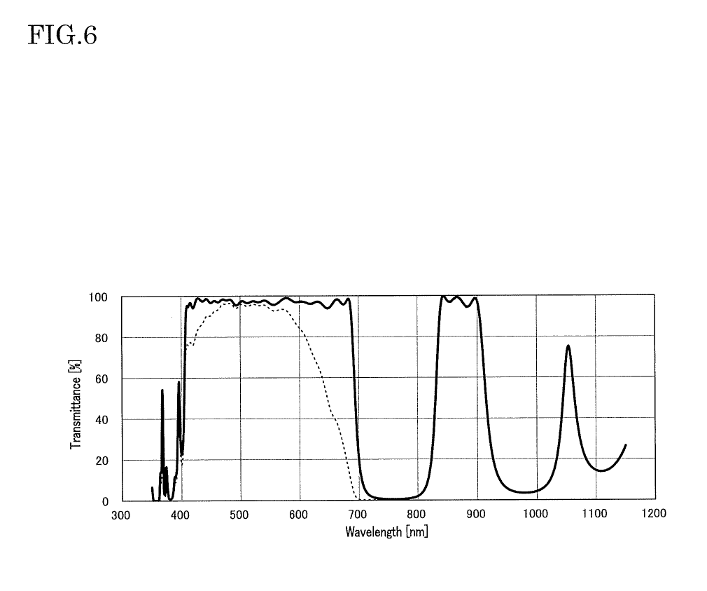

As shown in FIG. 6, the second filter 30 has transmission characteristics almost entirely in the visible region (400 nm to 700 nm) and partly in the near-infrared region (700 nm to 1100 nm). FIG. 6 shows, in solid line, filter characteristics of the second filter 30 when the incident angle of light α (see FIG. 1) is 0° (when rays are vertically incident). The broken line (thin line) in FIG. 6 represents filter characteristics of the first filter 20 (see FIG. 4) and the second filter 30, as combined.

Specifically, the second filter 30 has transmission characteristics almost entirely in the visible region (400 nm to 700 nm), with the transmittance falling drastically on the long-wavelength side (at wavelengths longer than 680 nm) in the visible region. In the visible region, the transmittance of the second filter 30 is 50% or higher in a wavelength band from the short-wavelength end in the visible region (400 nm) to about 694 nm, 80% or higher in a wavelength band from the short-wavelength end in the visible region (400 nm) to about 690 nm, 90% or higher in a wavelength band from about 408 nm to about 688 nm, and 95% or higher in a wavelength band from about 410 nm to about 686 nm.

The second filter 30 has transmission characteristics partly in the near-infrared region (700 nm to 1100 nm). In the second filter 30, the wavelength band having transmission characteristics in the near-infrared region is separated from the wavelength band having transmission characteristics in the visible region. In detail, the second filter 30 has transmission characteristics partly in a wavelength band from 800 nm to 950 nm, with the transmittance in the near-infrared region rising drastically at wavelengths longer than 800 nm and falling drastically at wavelengths shorter than 950 nm.

In the near-infrared region, the transmittance of the second filter 30 is 50% or higher in a wavelength band from about 830 nm to about 916 nm, 80% or higher in a wavelength band from about 836 nm to about 908 nm, 90% or higher in a wavelength band from about 838 nm to about 904 nm, and 95% or higher in a wavelength band from about 840 nm to about 902 nm.

Further, the second filter 30 has following cutoff characteristics in the vicinity of the boundary between the visible region and the near-infrared region. The transmittance of the second filter 30 is 20% or lower in a wavelength band from about 700 nm to about 824 nm, 10% or lower in a wavelength band from about 706 nm to about 818 nm, and 5% or lower in a wavelength band from about 712 nm to about 812 nm.

### Third Filter

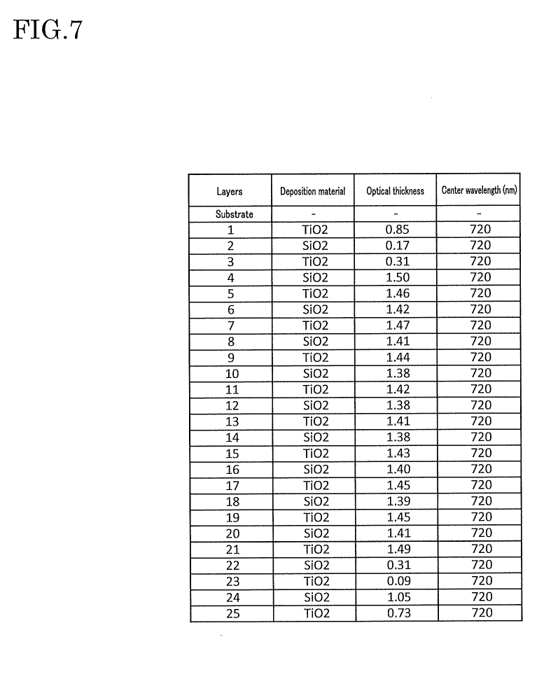

As shown in FIG. 2, the third filter 40 is made of a dielectric multilayer formed on a second surface 20B of the first filter 20. Specifically, as indicated in FIG. 7, the third filter 40 has an alternately laminated structure composed of high-refractive-index TiO₂ layers 40H and low-refractive-index SiO₂ layers 40L. The third filter 40 has a total of 25 layers including 12 high-refractive-index layers 40H and 13 low-refractive-index layers 40L. When counted from the first filter 20, the odd-numbered layers are the low-refractive-index layers 40L, and the even-numbered layers are the high-refractive-index layers 40H. This means that the first layer closest to the first filter 20 (the bottom layer) is a low-refractive-index layer 40L, and that the 25th layer closest to the atmosphere (the top layer) is also a low-refractive-index layer 40L. The order of laminating the high-refractive-index layers 40H and the low-refractive-index layers 40L are not limited to this example. In another mode of this embodiment, when counted from the first filter 20, the odd-numbered layers may be the high-refractive-index layers 40H, and the even-numbered layers may be the low-refractive-index layers 40L. In yet another mode of this embodiment, the number of high-refractive-index layers 40H and the number of low-refractive-index layers 40L may be equal, just as in the second filter 30 described above.

The material for the high-refractive-index layers 40H is TiO₂ in this embodiment, but is not limited thereto, and may be ZrO₂, Nb₂O₅, or Ta₂O₅, for example. In other words, a material having a refractive index of greater than 2.0 is preferable for the high-refractive-index layers 40H. Similarly, the material for the low-refractive-index layers 40L is SiO₂ in this embodiment, but is not limited thereto, and may be MgF₂ or the like. In other words, a material having a smaller refractive index than the high-refractive-index layers 40H is preferable for the low-refractive-index layers 40L, and a material having a refractive index of less than 1.5 is more preferable.

The constitutive layers of the third filter 40 (the low-refractive-index layers 40L and the high-refractive-index layers 40H) are vapor deposited alternately by known vacuum deposition equipment. The thickness of vapor deposition is designed by the optical thickness obtained as the product of the refractive index and the physical thickness. For example, the optical thickness of the third filter 40 is designed as indicated in FIG. 7. The center wavelength in FIG. 7 (720 nm) is the center wavelength for designing the film thickness.

As indicated in FIG. 7, the third filter 40 composed of the high-refractive-index layers 40H and the low-refractive-index layers 40L has a total of 25 layers and has a total film thickness (physical thickness) of about 3.0 μm. The second filter 30 preferably has 20 to 60 layers and preferably has a total film thickness of 2.4 μm to 7.2 μm.

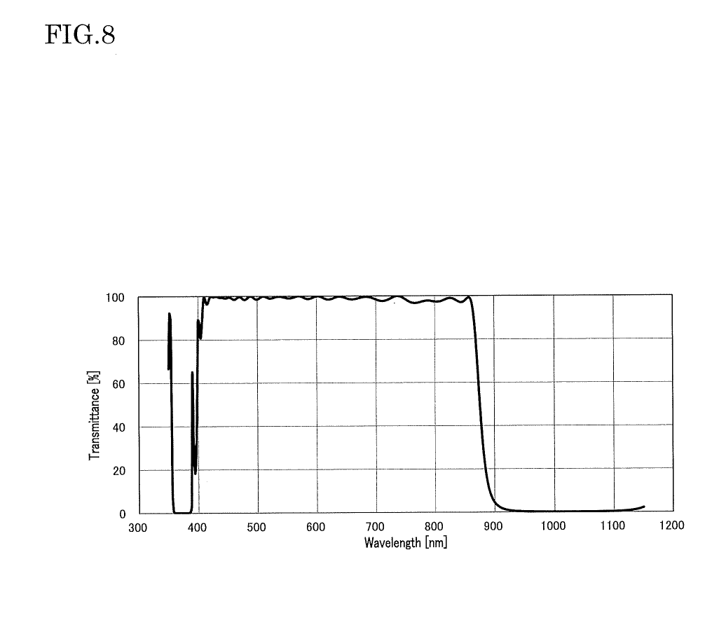

As shown in FIG. 8, the third filter 40 has transmission characteristics almost entirely in the visible region (400 nm to 700 nm) and on the short-wavelength side in the near-infrared region (700 nm to 1100 nm). FIG. 8 shows filter characteristics of the third filter 40 when the incident angle of light α (see FIG. 1) is 0° (when rays are vertically incident).

Specifically, the third filter 40 has transmission characteristics from the short-wavelength end in the visible region (400 nm) to the near-infrared region, with the transmittance falling drastically in the near-infrared region (at wavelengths shorter than 900 nm). Almost entirely in the visible region, the transmittance of the third filter 40 is 95% or higher. In the near-infrared region, the transmittance of the third filter 40 is 95% or higher from short-wavelength end in the near-infrared region (700 nm) to the wavelengths shorter than 900 nm. In this case, the transmittance of the third filter 40 is 95% at a wavelength of about 862 nm, 90% at a wavelength of about 866 nm, 80% at a wavelength of about 870 nm, and 50% at a wavelength of about 876 nm.

Further, the third filter 40 has following cutoff characteristics in the near-infrared region. The transmittance of the third filter 40 is 20% or lower in a wavelength band from about 886 nm to the long-wavelength end in the near-infrared region (1100 nm), 10% or lower in a wavelength band from about 892 nm to the long-wavelength end in the near-infrared region (1100 nm), and 5% or lower in a wavelength band from about 900 nm to the long-wavelength end in the near-infrared region (1100 nm).

### Optical Filter Characteristics

Filter characteristics of the first to third filters 20, 30, 40 in this embodiment are shown in FIG. 4, FIG. 6, and FIG. 8, respectively. Filter characteristics of the optical filter 10 as a whole are accumulation of the filter characteristics of the first filter 20, those of the second filter 30, and those of the third filter 40 (see FIG. 3). Namely, the waveform of transmittance of the first filter 20 (see FIG. 4), the waveform of transmittance of the second filter 30 (see FIG. 6), and the waveform of transmittance of the third filter 40 (see FIG. 8) are overlaid to give the waveform of transmittance of the optical filter 10 shown in FIG. 3. Accordingly, the filter characteristics of the optical filter 10 of this embodiment include transmission characteristics in two wavelength bands in the visible region and the near-infrared region, as shown in FIG. 3. In the optical filter 10, the wavelength band having transmission characteristics in the near-infrared region is separated from the wavelength band having transmission characteristics in the visible region.

Specifically, the optical filter 10 has transmission characteristics almost entirely in the visible region (400 nm to 700 nm), with the transmittance falling gently on the long-wavelength side (at wavelengths longer than 600 nm) in the visible region, as shown in FIG. 3. The optical filter 10 owes such characteristics in the visible region mainly to the first filter 20. On the long-wavelength side (at wavelengths longer than 600 nm) in the visible region, the waveform of falling transmittance of the optical filter 10 substantially follows the waveform of falling transmittance of the first filter 20. Since the transmittance of the second filter 30 and the transmittance of the third filter 40 are almost 100% (95% or higher) on the long-wavelength side in the visible region, the filter characteristics of the first filter 20 appear substantially directly as those of the optical filter 10.

To be more specific, in the visible region, the transmittance of the optical filter 10 is 50% or higher in a wavelength band from the short-wavelength end in the visible region (400 nm) to about 646 nm, 80% or higher in a wavelength band from about 420 nm to about 610 nm, 90% or higher in a wavelength band from about 450 nm to about 580 nm, and 95% or higher in a wavelength band from about 470 nm to about 540 nm.

Further referring to FIG. 3, the optical filter 10 has transmission characteristics partly in the near-infrared region. Namely, the optical filter 10 has cutoff characteristics in a first band A1 defined from the long-wavelength side in the visible region to the near-infrared region and in a third band A3 defined on the long-wavelength side relative to the first band A1, and the optical filter 10 has transmission characteristics in a second band A2 defined between the first band A1 and the third band A3.

The first band A1 starts on the long-wavelength side over 640 nm and ends on the long-wavelength side over 800 nm, including a cutoff band in which the transmittance is 5% or lower. The third band A3 starts on the short-wavelength side below 900 nm and ends at the long-wavelength end in the near-infrared region (1100 nm), including a cutoff band in which the transmittance is 5% or lower. The transmission band in the second band A2 is defined between the cutoff band in the first band A1 and the cutoff band in the third band A3. In the second band A2, the transmittance of the optical filter 10 reaches 50% at a wavelength longer than 800 nm (about 830 nm) and at a wavelength shorter than 900 nm (about 876 nm).

Specifically, as shown in FIG. 3, the wavelength band in which the transmittance in the first band A1 reaches 50% ranges from about 646 nm to about 830 nm. The wavelength band in which the transmittance in the second band A2 reaches 50% ranges from about 830 nm to about 876 nm. The wavelength band in which the transmittance in the third band A3 reaches 50% ranges from about 876 nm to the long-wavelength end in the near-infrared region (1100 nm).

The optical filter 10 has following cutoff characteristics in the first band A1. The transmittance of the optical filter 10 is 20% or lower in a wavelength band from about 680 nm to about 824 nm, 10% or lower from about 686 nm to about 818 nm, and 5% or lower from about 690 nm to about 812 nm. Thus, in the first band A1, the optical filter 10 has such characteristics that the transmittance rises drastically at wavelengths longer than 800 nm in the near-infrared region.

The optical filter 10 has following cutoff characteristics in the third band A3. The transmittance of the optical filter 10 is 20% or lower in a wavelength band from about 884 nm to the long-wavelength end in the near-infrared region (1100 nm), 10% or lower in a wavelength band from about 892 nm to the long-wavelength end in the near-infrared region (1100 nm), and 5% or lower in a wavelength band from about 900 nm to the long-wavelength end in the near-infrared region (1100 nm). Thus, in the third band A3, the optical filter 10 has such characteristics that the transmittance falls drastically at wavelengths shorter than 900 nm in the near-infrared region.

The optical filter 10 has following transmission characteristics in the second band A2. The transmittance of the optical filter 10 is 50% or higher in a wavelength band from about 830 nm to about 876 nm, 80% or higher in a wavelength band from about 836 nm to about 870 nm, 90% or higher in a wavelength band from about 840 nm to about 866 nm, and 95% or higher in a wavelength band from about 842 nm to about 864 nm. Thus, in the second band A2, the optical filter 10 has such characteristics that the transmittance rises drastically at wavelengths longer than 800 nm in the near-infrared region and falls drastically at wavelengths shorter than 900 nm in the near-infrared region.

In this embodiment, the first filter 20 provides the optical filter 10 with the cutoff characteristics on the short-wavelength side in the first band A1. The second filter 30 provides the optical filter 10 with the cutoff characteristics on the long-wavelength side in the first band A1 and the transmission characteristics on the short-wavelength side in the second band A2. The third filter 40 provides the optical filter 10 with the transmission characteristics on the long-wavelength side in the second band A2 and the cutoff characteristics on the short-wavelength side in the third band A3. In the optical filter 10, the cutoff band in which the transmittance is 5% or lower in the first band A1 has a bandwidth of at least 100 nm. This point is elucidated in the following description.

As shown in FIG. 3, in the near-infrared region of the first band A1, the cutoff band in which the transmittance of the optical filter 10 is 5% or lower is present from the short-wavelength end in the near-infrared region (700 nm) to the long-wavelength side over 800 nm. To be more specific, the cutoff band in the first band A1 is not limited within the near-infrared region but is continuous to the long-wavelength side in the visible region. Concretely, the cutoff band in the first band A1 ranges from about 690 nm to about 812 nm.

In the optical filter 10, the cutoff band in the first band A1 is provided by the first filter 20 and the second filter 30. Specifically, for the visible region, the cutoff band in the first band A1 substantially follows the filter characteristics of the first filter 20 in a wavelength band from the long-wavelength side in the visible region (about 690 nm) to the long-wavelength end in the visible region (700 nm). Since the transmittance of the first filter 20 is almost 0% (5% or lower) in the wavelength band from the long-wavelength side in the visible region (about 690 nm) to the long-wavelength end in the visible region (700 nm), the filter characteristics of the first filter 20 appear substantially directly as those of the optical filter 10.

For the near-infrared region, the cutoff band in the first band A1 is provided by the combination of the filter characteristics of the first filter 20 and those of the second filter 30, in a wavelength band from the short-wavelength end in the near-infrared region (700 nm) to the short-wavelength side in the near-infrared region (about 712 nm). In a wavelength band from the short-wavelength side in the near-infrared region (about 712 nm) to the long-wavelength side over 800 nm (about 812 nm), the cutoff band in the first band A1 substantially follows the filter characteristics of the second filter 30. Since the transmittance of the second filter 30 is almost 0% (5% or lower) in the wavelength band from the short-wavelength side in the near-infrared region (about 712 nm) to the long-wavelength side over 800 nm (about 812 nm), the filter characteristics of the second filter 30 appear substantially directly as those of the optical filter 10.

As described above, in the optical filter 10, the cutoff band in the first band A1 is provided by the first filter 20 and the second filter 30. In the optical filter 10, the cutoff band in which the transmittance is 5% or lower in the first band A1 in the near-infrared region is set to a bandwidth of at least 100 nm, and to a bandwidth of about 112 nm in this example. Taking the cutoff band in the near-infrared region and the cutoff band on the long-wavelength side in the visible region altogether, the cutoff band in which the transmittance in the first band A1 of the optical filter 10 is 5% or lower ranges from the long-wavelength side in the visible region to the near-infrared region, and this cutoff band has a bandwidth of about 122 nm.

Next, in the vicinity of the boundary between the first band A1 and the second band A2, the optical filter 10 has such filter characteristics that the transmittance rises drastically on the long-wavelength side over 800 nm in the near-infrared region. In a range from about 812 nm to about 842 nm, the transmittance of the optical filter 10 rises from 5% to 95%. In the optical filter 10, the cutoff characteristics on the long-wavelength side in the first band A1 and the transmission characteristics on the short-wavelength side in the second band A2 substantially follow the filter characteristics of the second filter 30. Since the transmittance of the first filter 20 and the transmittance of the third filter 40 are almost 100% (95% or higher) on the long-wavelength side over 800 nm in the near-infrared region (about 812 nm to about 842 nm), the filter characteristics of the second filter 30 appear substantially directly as those of the optical filter 10. In the optical filter 10, as described above, the second filter 30 provides the cutoff characteristics on the long-wavelength side in the first band A1 and the transmission characteristics on the short-wavelength side in the second band A2.

The second band A2 includes the transmission band in which the transmittance of the optical filter 10 is 95% or higher, in a wavelength band from the long-wavelength side over 800 nm to the short-wavelength side below 900 nm, specifically, in a wavelength band from about 842 nm to about 864 nm. In the optical filter 10, the transmission band in the second band A2 substantially follows the filter characteristics of the second filter 30 and those of the third filter 40. Since the transmittance of the first filter 20 and the transmittance of the third filter 40 are almost 100% (95% or higher) in the wavelength band from about 842 nm to about 864 nm, the filter characteristics of the second filter 30 appear substantially directly as those of the optical filter 10. In the optical filter 10, as described above, the second filter 30 provides the transmission band in the second band A2. In the optical filter 10 of this example, the transmission band in which the transmittance is 95% or higher in the second band A2 has a bandwidth of about 22 nm. In the optical filter 10 of this example, the transmission band in which the transmittance is 50% or higher in the second band A2 has a bandwidth of about 46 nm.

Next, in the vicinity of the boundary between the second band A2 and the third band A3, the optical filter 10 has such filter characteristics that the transmittance drops drastically on the short-wavelength side below 900 nm in the near-infrared region. In a range from about 864 nm to about 900 nm, the transmittance of the optical filter 10 drops from 95% to 5%. In the optical filter 10, the transmission characteristics on the long-wavelength side in the second band A2 and the cutoff characteristics on the short-wavelength side in the third band A3 substantially follow the filter characteristics of the third filter 40. Since the transmittance of the first filter 20 and the transmittance of the second filter 30 are almost 100% (95% or higher) on the short-wavelength side below 900 nm (about 864 nm to about 900 nm), the filter characteristics of the third filter 40 appear substantially directly as those of the optical filter 10. In the optical filter 10, as described above, the third filter 40 provides the transmission characteristics on the long-wavelength side in the second band A2 and the cutoff characteristics on the short-wavelength side in the third band A3.

Further, the third band A3 includes the cutoff band in which the transmittance of the optical filter 10 is 5% or lower, in a wavelength band from the short-wavelength side below 900 nm to the long-wavelength end in the near-infrared region (1100 nm). In the optical filter 10, the cutoff band in the third band A3 substantially follows the filter characteristics of the third filter 40. Since the transmittance of the third filter 40 is almost 0% (5% or lower) in a wavelength band from the short-wavelength side below 900 nm (about 900 nm) to the long-wavelength end in the near-infrared region (1100 nm), the filter characteristics of the third filter 40 appear substantially directly as those of the optical filter 10. In the optical filter 10, as described above, the third filter 40 provides the cutoff band in the third band A3. In the optical filter 10 of this example, the cutoff band in which the transmittance is 5% or lower in the third band A3 has a bandwidth of about 200 nm.

In the optical filter 10 of this embodiment, the cutoff band in which the transmittance is 5% or lower in the first band A1 is set to a bandwidth of at least 100 nm. The resulting optical filter ensures a wider cutoff band than conventional optical filters, and thereby ensures sufficient cutoff characteristics in the first band A1. As a result, the optical filter can sufficiently reduce transmission of the red component and can prevent color mixture caused by transmission of the red component. Eventually, the optical filter according to this embodiment can prevent deterioration of color reproducibility of an image taken by an imaging device. For the cutoff band in the first band A1, the upper limit of its bandwidth is not particularly limited, and may be 150 nm or even 250 nm, for example.

In this optical filter, the half-power wavelength of the second filter 30 (the wavelength at which the transmittance reaches 50%) is on the long-wavelength side relative to the half-power wavelength of the first filter 20. Absorption of light by the first filter 20 reduces the amount of light reflected by the second filter 30, and reduction of reflected light inhibits appearance of a ghost caused by reflection of light by the second filter 30.

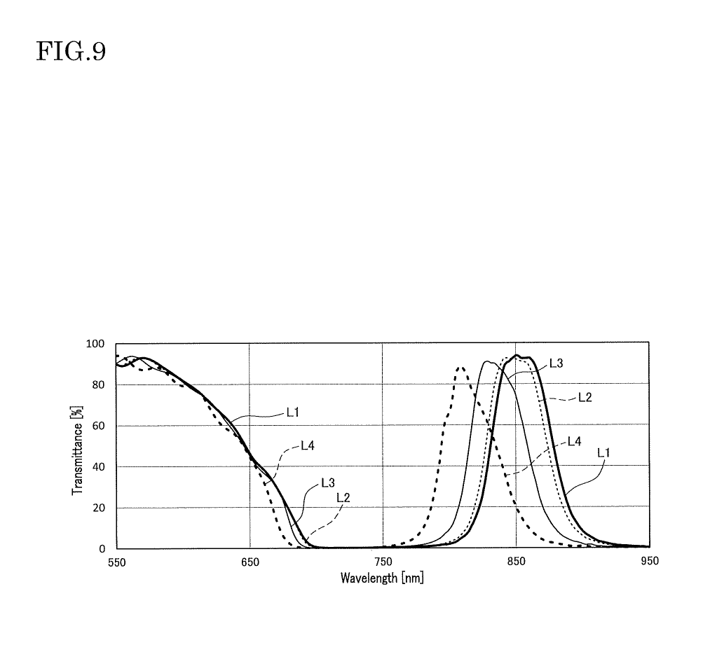

Further in this embodiment, the first filter 20 made of an infrared absorber (an infrared-absorbing resin) can make the optical filter 10 less dependent on the incident angle in the visible region than the first filter 20 made of a dielectric multilayer. Besides, the thus configured optical filter 10 can inhibit appearance of a ghost or flare in an image taken by the imaging device. This is explained with reference to FIG. 9. FIG. 9 represents partial filter characteristics of the optical filter 10 when incident angles of light α (see FIG. 1) are 0°, 10°, 20°, and 30°. L1 represents filter characteristics when the incident angle of light α is 0°. L2 represents filter characteristics when the incident angle of light α is 10°. L3 represents filter characteristics when the incident angle of light α is 20°. L4 represents filter characteristics when the incident angle of light α is 30°.

In the near-infrared region, if the incident angle of light α gets greater, the waveform for the optical filter 10 shifts to the short-wavelength side, as shown in FIG. 9. This is because the optical filter 10 owes its filter characteristics in the near-infrared region to the second and third filters 30, 40 each made of a dielectric multilayer. Thus, the optical filter 10 depends on the incident angle greatly in the near-infrared region. Heavy dependency on the incident angle may deteriorate detection efficiency in the near-infrared region when an imaging element is required to detect light at a specific wavelength only.

In the visible region, the shift of the waveforms for the optical filter 10 is smaller than in the near-infrared region. This is because the optical filter 10 owes its filter characteristics in the visible region to the first filter 20 made of an infrared absorber (an infrared-absorbing resin). Hence, in the visible region, the optical filter 10 in this embodiment can be less dependent on the incident angle and can thereby inhibit appearance of a ghost or flare in an image taken by an imaging device. The first filter 20 itself is hardly dependent on the incident angle, and the waveform shifts by only a few nanometers to the short-wavelength side even when the incident angle of light α is 30°. In other words, the dependency on the incident angle in the visible region as shown in FIG. 9 is not attributable to the first filter 20 but is mainly attributable to the second filter 30.

Also as mentioned above in this embodiment, the optical filter 10 owes its filter characteristics in the near-infrared region to the second and third filters 30, 40. To be more specific, the second filter 30 provides the optical filter 10 with the transmission characteristics on the short-wavelength side in the second band A2, and the third filter 40 provides the optical filter 10 with the transmission characteristics on the long-wavelength side in the second band A2. The thus configured optical filter 10 can easily change the bandwidth of the transmission band in which the transmittance is 50% or higher in the second band A2, and can flexibly meet various demands to its filter characteristics in the near-infrared region. Preferably, in the second band A2 of the optical filter 10, the bandwidth of the transmission band in which the transmittance is 50% or higher is set in a range from 35 nm to 200 nm. In this case, the wavelength band in which the transmittance in the second band A2 reaches 50% is preferably set in a range from 800 nm to 1000 nm. For example, if the bandwidth of the transmission band in the second band A2 is set to 200 nm, the third filter 40 are designed with such filter characteristics that the transmittance drops drastically at wavelengths around 1000 nm.

For the second filter 30 in this embodiment, the thickness ratio of the average optical thickness of the low-refractive-index layers 30L to the average optical thickness of the high-refractive-index layers 30H [the average optical thickness of the low-refractive-index layers 30L/the average optical thickness of the high-refractive-index layers 30H] is set in a range from 0.50 to 0.85. As a result, the cutoff band that has cutoff characteristics derived from the second filter 30 can be narrower, and the transmission band (the second band A2) can be set in a desired range in the near-infrared region, separately from the transmission band in the visible region.

In this embodiment, the bandwidth of wavelengths in which the transmittance in the first band A1 reaches 50% is greater than the bandwidth of wavelengths in which the transmittance of the first filter 20 reaches 50% and the bandwidth of wavelengths in which the transmittance of the second filter 30 reaches 50%. Hence, the transmission band (the second band A2) can be set in a desired range in the near-infrared region by means of the first and second filters 20, 30.

The embodiment disclosed above is considered in all respects as illustrative and not restrictive. The technical scope of the present invention is indicated by the appended claims rather than by the foregoing embodiment alone. The technical scope of the present invention is intended to embrace all variations and modifications falling within the equivalency range of the appended claims.

In the above-described embodiment, the optical filter 10 has transmission characteristics almost entirely in the visible region. Instead, the optical filter 10 may be configured to have transmission characteristics only partly in the visible region.

The first filter 20 in the above-described embodiment is merely given as an example, and may have a different configuration as long as the wavelength at which the transmittance reaches 50% in the visible region is in a range from 640 nm to 660 nm and the absorption maximum is in a range from 650 nm to 800 nm. For example, the first filter 20 in the above-described embodiment is an infrared absorber in which a transparent resin contains an infrared-absorbing compound. Instead, the first filter 20 may be an infrared absorber in which an infrared-absorbing compound (an infrared absorption ink) is applied to a surface of a substrate such as glass.

The second filter 30 in the above-described embodiment is merely given as an example, and may have a different configuration as long as the wavelength at which the transmittance of the second filter 30 reaches 50% ranges from 685 nm to 710 nm and the cutoff band in which the transmittance is 5% or lower is provided in a range of at least 100 nm in the near-infrared region. For example, the second filter 30 may be an assembly of a plurality of filters (dielectric multilayers). Likewise, the third filter 40 may also be an assembly of a plurality of filters (dielectric multilayers).

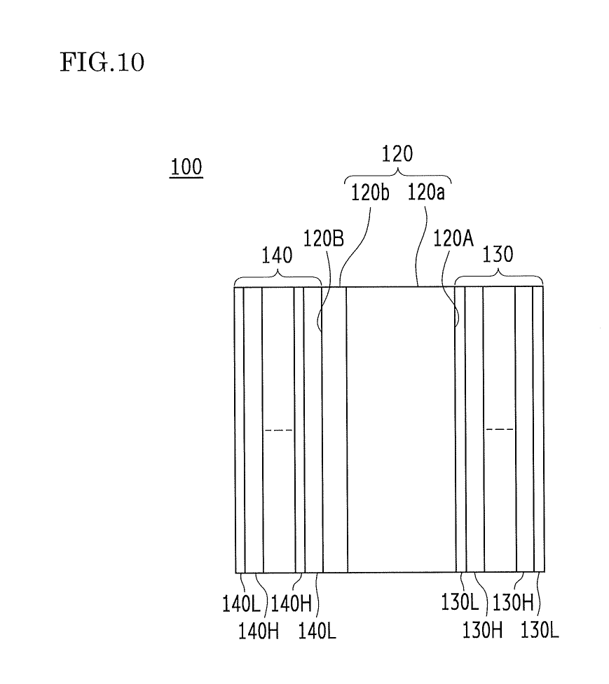

Turning next to FIGS. 10 to 15, an optical filter according to another embodiment (the second embodiment) of the present invention is described.

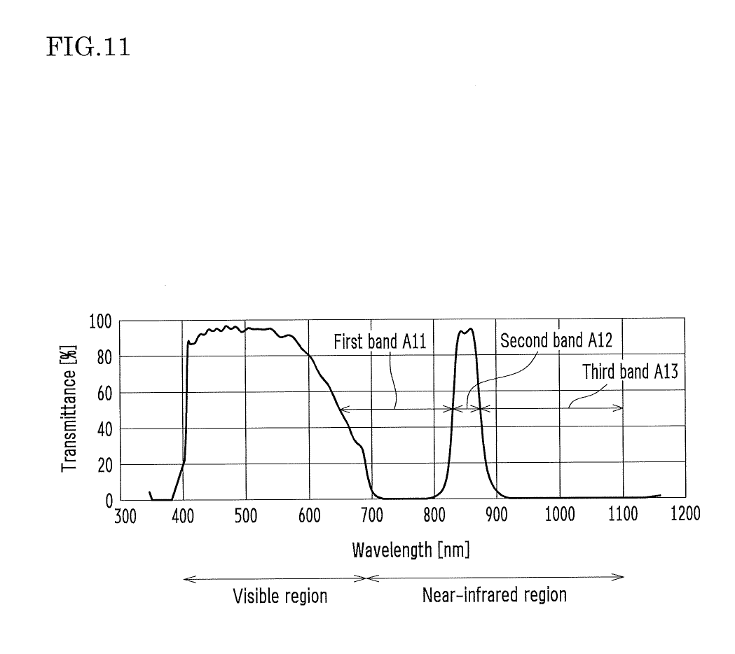

The optical filter 100 shown in FIGS. 10 to 15, to be provided in an imaging device, has transmission characteristics in two wavelength bands in the visible region and the near-infrared region. The wavelength band having transmission characteristics in the visible region and the wavelength band having transmission characteristics in the near-infrared region are separated from each other. Specifically, as shown in FIG. 10, the optical filter 100 has a first filter 120 made of an infrared absorber, a second filter 130 made of a dielectric multilayer and applied to one surface of the first filter 120, and a third filter 140 made of a dielectric multilayer and applied to the other surface of the first filter 120. The optical filter 100 has filter characteristics (a waveform of transmittance) as shown in FIG. 11. The constituents of the optical filter 100 are detailed below.

### First Filter

In this embodiment, the first filter 120 as the infrared absorber is composed of a transparent base (a transparent substrate) 120a and an infrared absorption ink (an infrared absorption dye) 120b for absorbing infrared rays and applied to a surface of the transparent base 120a. The transparent base 120a is a colorless transparent glass substrate, which may be, for example, D 263 T eco (manufactured by SCHOTT AG), BK7, etc. The infrared absorption dye 120b may be, for example, a squarylium-based dye, a phthalocyanine-based dye, a cyanine-based dye or the like. A coating solution of the infrared absorption dye 120b mixed with a transparent resin, a solvent or the like is applied to the surface of the transparent base 120a. When the transparent base 120a is a glass substrate, the transparent base 120a can improve rigidity of the first filter 120 and can prevent distortion of the first filter 120 caused by the stress during the formation of the second and third filters 130, 140 to be described later. Having said that, the transparent base 120a may not necessarily be glass and simply needs to be a colorless transparent base. For example, the transparent base 120a may be also made of a transparent resin such as polyethylene terephthalate, polycarbonate, or cycloolefin polymer.

The first filter 120 having the above configuration is produced, for example, by the following process.

To start with, the infrared absorption dye 120b is mixed with a transparent resin, a solvent or the like to give a coating solution containing the infrared absorption dye 120b (the coating solution preparation step). In an example, methyl ethyl ketone (a transparent resin) is mixed with 5 to 15 wt % of polymethyl methacrylate (a solvent) to give a solution in which polymethyl methacrylate is dissolved. To this solution, 0.1 to 1.0 wt % of cyanine-based infrared-absorbing dye (an infrared absorption dye 120b) is added to give a coating solution containing the infrared absorption dye 120b. The transparent resin may be, for example, an acrylic-based resin, an epoxy-based resin, a polystyrene-based resin, a polyester-based resin, an annular olefin-based resin, etc. The solvent may be, for example, a ketone-based solvent (e.g., methyl ethyl ketone), a hydrocarbon-based solvent (e.g., toluene), an ester-based solvent (e.g., methyl acetate), an ether-based solvent (e.g., tetrahydrofuran), an alcohol-based solvent (e.g., ethanol), etc. Where necessary, a polymerization initiator such as a photopolymerization initiator or a thermal polymerization initiator may be also added. If the infrared absorption dye 120b is commercially available in the form of a coating material (e.g., an epoxy resin coating material), the commercial coating material of the infrared absorption dye 120b may be applied to the transparent base 120a, in which case the coating solution preparation step can be omitted.

Next, the coating solution of the infrared absorption dye 120b prepared in the coating solution preparation step is uniformly applied to the surface of the transparent base 120a in a predetermined thickness (the coating step). In the coating step, the coating solution is applied with use of, for example, a spin coater, a die coater, or a bar coater.

After the coating step, the transparent base 120a coated with the coating solution is dried to volatilize the solvent contained in the coating solution so as to cure the transparent resin contained in the coating solution (the drying step). In the drying step, volatilization of the solvent and curing of the transparent resin are carried out under heating, for example, by means of an oven or a hot plate, at about 100° C. for about five minutes. If a photopolymerization initiator is added, the transparent resin is allowed to cure by photopolymerization.

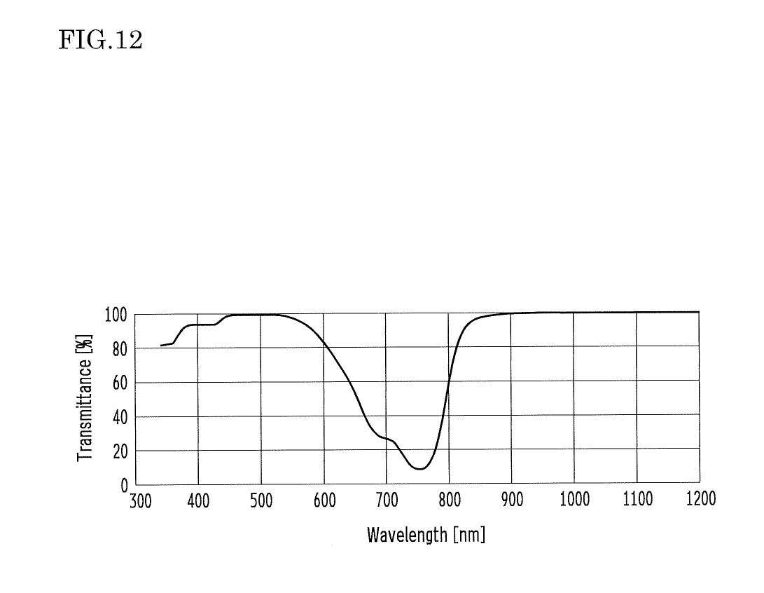

As shown in FIG. 12, the first filter 120 has an absorption maximum, where the transmittance is minimum, in the vicinity of the boundary between the visible region and the near-infrared region. FIG. 12 shows filter characteristics of the first filter 120 when the incident angle of light α (see FIG. 1) is 0° (when rays are vertically incident).

Specifically, the first filter 120 has transmission characteristics almost entirely in the visible region (400 nm to 700 nm), with the transmittance falling gently on the long-wavelength side (at wavelengths longer than 600 nm) in the visible region. In the visible region, the transmittance of the first filter 120 is 50% or higher in a wavelength band from the short-wavelength end in the visible region (400 nm) to about 654 nm, 80% or higher in a wavelength band from the short-wavelength end in the visible region (400 nm) to about 606 nm, 90% or higher in a wavelength band from the short-wavelength end in the visible region (400 nm) to about 584 nm, and 95% or higher in a wavelength band from about 434 nm to about 564 nm.

The first filter 120 also has transmission characteristics almost entirely in the near-infrared region (700 nm to 1100 nm), with the transmittance rising on the short-wavelength side (at wavelengths shorter than 750 nm) in the near-infrared region. In the near-infrared region, the transmittance of the first filter 120 is 50% or higher in a wavelength band from about 796 nm to the long-wavelength end in the near-infrared region (1100 nm), 80% or higher in a wavelength band from about 814 nm to the long-wavelength end in the near-infrared region (1100 nm), 90% or higher in a wavelength band from about 826 nm to the long-wavelength end in the near-infrared region (1100 nm), and 95% or higher in a wavelength band from about 838 nm to the long-wavelength end in the near-infrared region (1100 nm). In the first filter 120, the rate of change (the rate of increase) in transmittance on the short-wavelength side in the near-infrared region is greater than the rate of change (the rate of decrease) in transmittance on the long-wavelength side in the visible region.

Further, the first filter 120 has following absorption characteristics in the vicinity of the boundary between the visible region and the near-infrared region. The transmittance of the first filter 120 is 20% or lower in a wavelength band from about 722 nm to about 778 nm, 10% or lower in a wavelength band from about 742 nm to about 762 nm, and is minimum (about 8.6%) at the wavelength of about 752 nm (absorption maximum). The absorption maximum of the first filter 120, which is at the wavelength of about 752 nm in this embodiment, simply needs to be in a range from 650 nm to 800 nm.

### Second Filter

As shown in FIG. 10, the second filter 130 is made of a dielectric multilayer formed on a first surface 120A of the first filter 120. The first surface 120A of the first filter 120 in this embodiment is a surface not coated with the infrared absorption dye 120b, and is provided with the second filter 130. In other words, the second filter 130 is formed on the surface of the transparent base 120a of the first filter 120.

The second filter 130 has an alternately laminated structure composed of high-refractive-index TiO₂ layers 130H and low-refractive-index SiO₂ layers 130L. For the second filter 130 in this embodiment, the second filter 30 and the third filter 40 in the optical filter 10 of above First Embodiment are combined as a single filter. Thus, the second filter 130 is a combination of a plurality of filters. To be more specific, a dielectric multilayer substantially identical to the second filter 30 in the optical filter 10 of First Embodiment (see FIG. 5) is formed on the first surface 120A of the first filter 120, and another dielectric multilayer substantially identical to the third filter 40 (see FIG. 7) in the optical filter 10 of First Embodiment is further formed on this dielectric multilayer.

The second filter 130 has a total of 55 layers including 27 high-refractive-index layers 130H and 28 low-refractive-index layers 130L. When counted from the first filter 120, the odd-numbered layers are the low-refractive-index layers 130L, and the even-numbered layers are the high-refractive-index layers 130H. This means that the first layer closest to the first filter 120 (the bottom layer) is a low-refractive-index layer 130L, and that the 55th layer closest to the atmosphere (the top layer) is also a low-refractive-index layer 130L. The order of laminating the high-refractive-index layers 130H and the low-refractive-index layers 130L are not limited to this example. In another mode of this embodiment, when counted from the first filter 120, the odd-numbered layers may be the high-refractive-index layers 130H, and the even-numbered layers may be the low-refractive-index layer 130L. In yet another mode of this embodiment, the number of high-refractive-index layers 130H and the number of low-refractive-index layers 130L may be equal.

The material for the high-refractive-index layers 130H is TiO₂ in this embodiment, but is not limited thereto, and may be ZrO₂, Nb₂O₅, or Ta₂O₅, for example. In other words, a material having a refractive index of greater than 2.0 is preferable for the high-refractive-index layers 130H. Similarly, the material for the low-refractive-index layers 130L is SiO₂ in this embodiment, but is not limited thereto, and may be MgF₂ or the like. In other words, a material having a smaller refractive index than the high-refractive-index layers 130H is preferable for the low-refractive-index layers 130L, and a material having a refractive index of less than 1.5 is more preferable.

The constitutive layers of the second filter 130 (the low-refractive-index layers 130L and the high-refractive-index layers 130H) are vapor deposited alternately by known vacuum deposition equipment, on the surface of the first filter 120 not coated with the infrared absorption dye 120b. The thickness of vapor deposition is designed by the optical thickness obtained as the product of the refractive index and the physical thickness. The constitutive layers of the second filter 130 (the low-refractive-index layers 130L and the high-refractive-index layers 130H) are substantially identical to those of the second and third filters 30, 40 in the optical filter 10 of First Embodiment (see FIGS. 5 and 7), and are not described herein. In the second filter 130, the average optical thickness of the low-refractive-index layers 130L is less than that of the high-refractive-index layers 130H, just as in the optical filter 10 of First Embodiment. The thickness ratio of the average optical thickness of the low-refractive-index layers 130L to the average optical thickness of the high-refractive-index layers 130H [the average optical thickness of the low-refractive-index layers 130L/the average optical thickness of the high-refractive-index layers 130H] is preferably from 0.50 to 0.85.

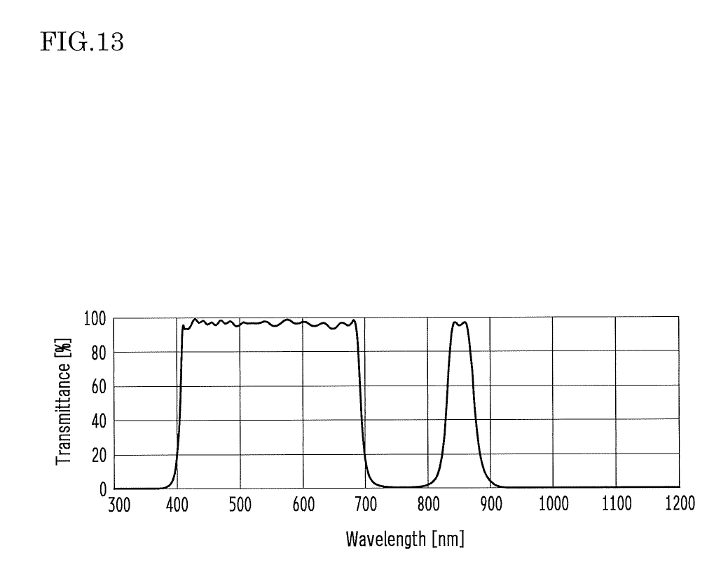

As shown in FIG. 13, the second filter 130 has transmission characteristics almost entirely in the visible region (400 nm to 700 nm) and partly in the near-infrared region (700 nm to 1100 nm). FIG. 13 shows filter characteristics of the second filter 130 when the incident angle of light α (see FIG. 1) is 0° (when rays are vertically incident).

Specifically, the second filter 130 has transmission characteristics almost entirely in the visible region (400 nm to 700 nm), with the transmittance falling drastically on the long-wavelength side (at wavelengths longer than 680 nm) in the visible region. In the visible region, the transmittance of the second filter 130 is 50% or higher in a wavelength band from about 406 nm to about 694 nm, 80% or higher in a wavelength band from about 408 nm to about 690 nm, 90% or higher in a wavelength band from about 408 nm to about 688 nm, and 95% or higher in a wavelength band from about 410 nm to about 686 nm.

The second filter 130 has transmission characteristics partly in the near-infrared region (700 nm to 1100 nm). In the second filter 130, the wavelength band having transmission characteristics in the near-infrared region is separated from the wavelength band having transmission characteristics in the visible region. In detail, the second filter 130 has transmission characteristics partly in the wavelength band from 800 nm to 950 nm, with the transmittance in the near-infrared region rising drastically at wavelengths longer than 800 nm and falling drastically at wavelengths shorter than 950 nm.

In the near-infrared region, the transmittance of the second filter 130 is 50% or higher in a wavelength band from about 830 nm to about 876 nm, 80% or higher in a wavelength band from about 836 nm to about 868 nm, 90% or higher in a wavelength band from about 838 nm to about 866 nm, and 95% or higher in a wavelength band from about 840 nm to about 862 nm.

Further, the second filter 130 has following cutoff characteristics in the vicinity of the boundary between the visible region and the near-infrared region. The transmittance of the second filter 130 is 20% or lower in a wavelength band from about 700 nm to about 824 nm, 10% or lower in a wavelength band from about 706 nm to about 818 nm, and 5% or lower in a wavelength band from about 712 nm to about 812 nm.

### Third Filter

As shown in FIG. 10, the third filter 140 is made of a dielectric multilayer formed on a second surface 120B of the first filter 120. The second surface 120B of the first filter 120 in this embodiment is a surface on which the infrared absorption dye 120b is applied and on which the third filter 140 is provided. In other words, the third filter 140 is formed on the surface of the infrared absorption dye 120b of the first filter 120.

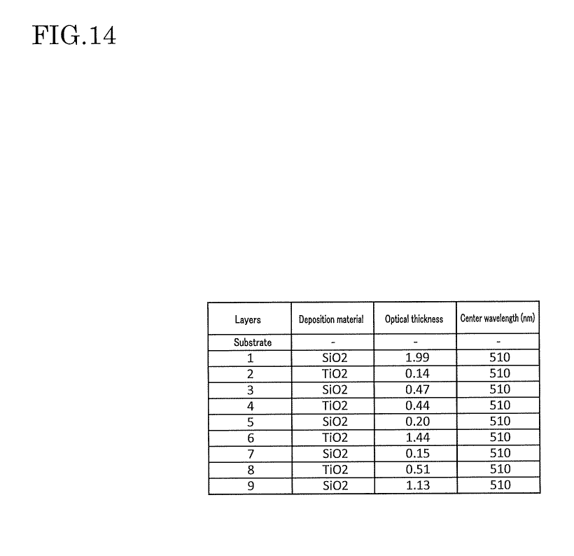

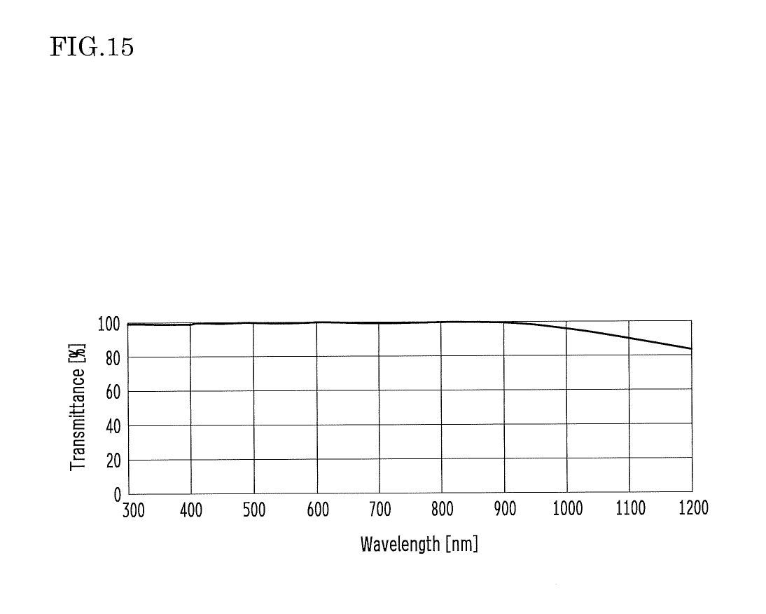

In this embodiment, the third filter 140 is configured as an antireflective film having filter characteristics as shown in FIG. 15. Specifically, as indicated in FIG. 14, the third filter 140 has an alternately laminated structure composed of high-refractive-index TiO₂ layers 140H and low-refractive-index SiO₂ layers 140L. The third filter 140 has a total of nine layers including four high-refractive-index layers 140H and five low-refractive-index layers 140L. When counted from the first filter 120, the odd-numbered layers are the low-refractive-index layers 140L, and the even-numbered layers are the high-refractive-index layers 140H. This means that the first layer closest to the first filter 120 (the bottom layer) is a low-refractive-index layer 140L, and that the ninth layer closest to the atmosphere (the top layer) is also a low-refractive-index layer 140L. The order of laminating the high-refractive-index layers 140H and the low-refractive-index layers 140L are not limited to this example. In another mode of this embodiment, when counted from the first filter 120, the odd-numbered layers may be the high-refractive-index layers 140H, and the even-numbered layers may be the low-refractive-index layers 140L. In yet another mode of this embodiment, the number of high-refractive-index layers 140H and the number of low-refractive-index layers 140L may be equal.

The material for the high-refractive-index layers 140H is TiO₂ in this embodiment, but is not limited thereto, and may be ZrO₂, Nb₂O₅, or Ta₂O₅, for example. In other words, a material having a refractive index of greater than 2.0 is preferable for the high-refractive-index layers 140H. Similarly, the material for the low-refractive-index layers 140L is SiO₂ in this embodiment, but is not limited thereto, and may be MgF₂ or the like. In other words, a material having a smaller refractive index than the high-refractive-index layers 140H is preferable for the low-refractive-index layers 140L, and a material having a refractive index of less than 1.5 is more preferable.

The constitutive layers of the third filter 140 (the low-refractive-index layers 140L and the high-refractive-index layers 140H) are vapor deposited alternately by known vacuum deposition equipment, on the surface of the first filter 120 coated with the infrared absorption dye 120b. The thickness of vapor deposition is designed by the optical thickness obtained as the product of the refractive index and the physical thickness. For example, the optical thickness of the third filter 140 is designed as indicated in FIG. 14. The center wavelength in FIG. 14 (510 nm) is the center wavelength for designing the film thickness.

As shown in FIG. 15, the third filter 140 has transmission characteristics almost entirely in the visible region (400 nm to 700 nm) and almost entirely in the near-infrared region (700 nm to 1100 nm). FIG. 15 shows filter characteristics of the third filter 140 when the incident angle of light α (see FIG. 1) is 0° (when rays are vertically incident). Specifically, almost entirely in the entire visible region, the transmittance of the third filter 140 is 95% or higher. In the near-infrared region, the transmittance of the third filter 140 is 95% or higher from the short-wavelength end in the near-infrared region (700 nm) to the wavelengths shorter than 900 nm. In this case, the transmittance of the third filter 140 is 95% at a wavelength of about 1012 nm, and is 90.4% at the long-wavelength end in the near-infrared region (1100 nm).

### Optical Filter Characteristics

Filter characteristics of the first to third filters 120, 130, 140 in this embodiment are shown in FIG. 12, FIG. 13, and FIG. 15, respectively. Filter characteristics of the optical filter 100 as a whole are accumulation of the filter characteristics of the first filter 120, those of the second filter 130, and those of the third filter 140 (see FIG. 11). Namely, the waveform of transmittance of the first filter 120 (see FIG. 12), the waveform of transmittance of the second filter 130 (see FIG. 13), and the waveform of transmittance of the third filter 140 (see FIG. 15) are overlaid to give the waveform of transmittance of the optical filter 100 as shown in FIG. 11. Accordingly, the filter characteristics of the optical filter 100 of this embodiment include transmission characteristics in two wavelength bands in the visible region and the near-infrared region, as shown in FIG. 11. In the optical filter 100, the wavelength band having transmission characteristics in the near-infrared region is separated from the wavelength band having transmission characteristics in the visible region.

Specifically, the optical filter 100 has transmission characteristics almost entirely in the visible region (400 nm to 700 nm), with the transmittance falling gently on the long-wavelength side (at wavelengths longer than 600 nm) in the visible region, as shown in FIG. 11. The optical filter 100 owes such characteristics in the visible region mainly to the first filter 120. On the long-wavelength side (at wavelengths longer than 600 nm) in the visible region, the waveform of falling transmittance of the optical filter 100 substantially follows the waveform of falling transmittance of the first filter 120. Since the transmittance of the second filter 130 and the transmittance of the third filter 140 are almost 100% (95% or higher) on the long-wavelength side in the visible region, the filter characteristics of the first filter 120 appear substantially directly as those of the optical filter 100.

To be more specific, in the visible region, the transmittance of the optical filter 100 is 50% or higher in a wavelength band from the short-wavelength end in the visible region (400 nm) to about 650 nm, 80% or higher in a wavelength band from about 408 nm to about 602 nm, 90% or higher in a wavelength band from about 424 nm to about 576 nm, and 95% or higher in a wavelength band from about 454 nm to about 540 nm.

Further referring to FIG. 11, the optical filter 100 has transmission characteristics partly in the near-infrared region. Namely, the optical filter 100 has cutoff characteristics in a first band A11 defined from the long-wavelength side in the visible region to the near-infrared region and in a third band A13 defined on the long-wavelength side relative to the first band A11, and the optical filter 100 has transmission characteristics in a second band A12 defined between the first band A11 and the third band A13.

The first band A11 starts on the long-wavelength side over 640 nm and ends on the long-wavelength side over 800 nm, including a cutoff band in which the transmittance is 5% or lower. The third band A13 starts on the short-wavelength side below 900 nm and ends at the long-wavelength end in the near-infrared region (1100 nm), including a cutoff band in which the transmittance is 5% or lower. The transmission band in the second band A12 is defined between the cutoff band in the first band A11 and the cutoff band in the third band A13. In the second band A12, the transmittance of the optical filter 100 reaches 50% at wavelengths longer than 800 nm (about 832 nm) and at wavelengths shorter than 900 nm (about 874 nm).

Specifically, as shown in FIG. 11, the transmittance in the first band A11 reaches 50% in a wavelength band from about 650 nm to about 832 nm. The transmittance in the second band A12 reaches 50% in a wavelength band from about 832 nm to about 874 nm. The transmittance in the third band A13 reaches 50% in a wavelength band from about 874 nm to the long-wavelength end in the near-infrared region (1100 nm).

The optical filter 100 has following cutoff characteristics in the first band A11. The transmittance of the optical filter 100 is 20% or lower in a wavelength band from about 690 nm to about 824 nm, 10% or lower from about 696 nm to about 820 nm, and 5% or lower from about 700 nm to about 814 nm. Thus, in the first band A11, the optical filter 100 has such characteristics that the transmittance rises drastically at wavelengths longer than 800 nm in the near-infrared region.

The optical filter 100 has following cutoff characteristics in the third band A13. The transmittance of the optical filter 100 is 20% or lower in a wavelength band from about 884 nm to the long-wavelength end in the near-infrared region (1100 nm), 10% or lower in a wavelength band from about 890 nm to the long-wavelength end in the near-infrared region (1100 nm), and 5% or lower in a wavelength band from about 898 nm to the long-wavelength end in the near-infrared region (1100 nm). Thus, in the third band A13, the optical filter 100 has such characteristics that the transmittance falls drastically at wavelengths shorter than 900 nm in the near-infrared region.

The optical filter 100 has following transmission characteristics in the second band A12. The transmittance of the optical filter 100 is 50% or higher in a wavelength band from about 832 nm to about 874 nm, 80% or higher in a wavelength band from about 836 nm to about 868 nm, and 90% or higher in a wavelength band from about 840 nm to about 864 nm. Thus, in the second band A12, the optical filter 100 has such characteristics that the transmittance rises drastically at wavelengths longer than 800 nm in the near-infrared region and falls drastically at wavelengths shorter than 900 nm in the near-infrared region.

In this embodiment, the first filter 120 and the second filter 130 provide the optical filter 100 with the cutoff characteristics on the short-wavelength side in the first band A11. The second filter 130 also provides the optical filter 100 with the cutoff characteristics on the long-wavelength side in the first band A11 and the transmission characteristics on the short-wavelength side in the second band A12. The second filter 130 further provides the optical filter 100 with the transmission characteristics on the long-wavelength side in the second band A12 and the cutoff characteristics on the short-wavelength side in the third band A13. In the optical filter 100, the cutoff band in which the transmittance is 5% or lower in the first band A11 has a bandwidth of at least 100 nm. This point is elucidated in the following description.

As shown in FIG. 11, in the near-infrared region of the first band A11, the cutoff band in which the transmittance of the optical filter 100 is 5% or lower is provided from the short-wavelength end in the near-infrared region (700 nm) to the long-wavelength side over 800 nm. The cutoff band in the first band A11 ranges from about 700 nm to about 814 nm.

In the optical filter 100, the cutoff band in the first band A11 is provided by the first filter 120 and the second filter 130. Namely, for the near-infrared region, the cutoff band in the first band A11 is provided by the combination of the filter characteristics of the first filter 120 and those of the second filter 130, in a wavelength band from the short-wavelength end in the near-infrared region (700 nm) to the short-wavelength side in the near-infrared region (about 712 nm). In a wavelength band from the short-wavelength side in the near-infrared region (about 712 nm) to the long-wavelength side over 800 nm (about 814 nm), the cutoff band in the first band A11 substantially follows the filter characteristics of the second filter 130. Since the transmittance of the second filter 130 is almost 0% (5% or lower) in the wavelength band from the short-wavelength side in the near-infrared region (about 712 nm) to the long-wavelength side over 800 nm (about 814 nm), the filter characteristics of the second filter 130 appear substantially directly as those of the optical filter 100.

As described above, in the optical filter 100, the cutoff band in the first band A11 is provided by the first filter 120 and the second filter 130. In the optical filter 100, the cutoff band in which the transmittance is 5% or lower in the first band A11 in the near-infrared region is set to a bandwidth of at least 100 nm, and to a bandwidth of about 112 nm in this example.

Next, in the vicinity of the boundary between the first band A11 and the second band A12, the optical filter 100 has such filter characteristics that the transmittance rises drastically on the long-wavelength side over 800 nm in the near-infrared region. In a range from about 814 nm to about 840 nm, the transmittance of the optical filter 100 rises from 5% to 90%. In the optical filter 100, the cutoff characteristics on the long-wavelength side in the first band A11 and the transmission characteristics on the short-wavelength side in the second band A12 substantially follow the filter characteristics of the second filter 130. Since the transmittance of the first filter 120 and the transmittance of the third filter 140 are almost 100% (95% or higher) in the long-wavelength side over 800 nm in the near-infrared region (about 814 nm to about 840 nm), the filter characteristics of the second filter 130 appear substantially directly as those of the optical filter 100. In the optical filter 100, as described above, the second filter 130 provides the cutoff characteristics on the long-wavelength side in the first band A11 and the transmission characteristics on the short-wavelength side in the second band A12.

The second band A12 includes the transmission band in which the transmittance of the optical filter 100 is 90% or higher, in a wavelength band from the long-wavelength side over 800 nm to the short-wavelength side below 900 nm, specifically, in a wavelength band from about 840 nm to about 864 nm. In the optical filter 100, the transmission band in the second band A12 substantially follows the filter characteristics of the second filter 130. Since the transmittance of the first filter 120 and the transmittance of the third filter 140 are almost 100% (95% or higher) in the wavelength band from about 840 nm to about 864 nm, the filter characteristics of the second filter 130 appear substantially directly as those of the optical filter 100. In the optical filter 100, as described above, the second filter 130 provides the transmission band in the second band A12. In the optical filter 100 of this example, the transmission band in which the transmittance is 90% or higher in the second band A12 has a bandwidth of about 24 nm. In the optical filter 100 of this example, the transmission band in which the transmittance is 50% or higher in the second band A12 has a bandwidth of about 42 nm.

Next, in the vicinity of the boundary between the second band A12 and the third band A13, the optical filter 100 has such filter characteristics that the transmittance drops drastically on the short-wavelength side below 900 nm in the near-infrared region. In a range from about 864 nm to about 898 nm, the transmittance of the optical filter 100 drops from 90% to 5%. In the optical filter 100, the transmission characteristics on the long-wavelength side in the second band A12 and the cutoff characteristics on the short-wavelength side in the third band A13 substantially follow the filter characteristics of the second filter 130. Since the transmittance of the first filter 120 and the transmittance of the third filter 140 are almost 100% (95% or higher) on the short-wavelength side below 900 nm (about 864 nm to about 898 nm), the filter characteristics of the second filter 130 appear substantially directly as those of the optical filter 100. In the optical filter 100, as described above, the second filter 130 provides the transmission characteristics on the long-wavelength side in the second band A12 and the cutoff characteristics on the short-wavelength side in the third band A13.

Further, the third band A13 includes the cutoff band in which the transmittance of the optical filter 100 is 5% or lower, in a wavelength band from the short-wavelength side below 900 nm to the long-wavelength end in the near-infrared region (1100 nm). In the optical filter 100, the cutoff band in the third band A13 substantially follows the filter characteristics of the second filter 130. Since the transmittance of the second filter 130 is almost 0% (5% or lower) in a wavelength band from the short-wavelength side below 900 nm (about 898 nm) to the long-wavelength end in the near-infrared region (1100 nm), the filter characteristics of the second filter 130 appear substantially directly as those of the optical filter 100. In the optical filter 100, as described above, the second filter 130 provides the cutoff band in the third band A13. In the optical filter 100 of this example, the cutoff band in which the transmittance is 5% or lower in the third band A13 has a bandwidth of about 202 nm.

In the optical filter 100 of this embodiment, just as in First Embodiment described above, the bandwidth of the cutoff band in which the transmittance is 5% or lower in the first band A11 is set to at least 100 nm. The resulting optical filter ensures a wider cutoff band than conventional optical filters, and thereby ensures sufficient cutoff characteristics in the first band A11. As a result, the optical filter can sufficiently reduce transmission of the red component and can prevent color mixture caused by transmission of the red component. Eventually, the optical filter according to this embodiment can prevent deterioration of color reproducibility of an image taken by an imaging device. For the cutoff band in the first band A11, the upper limit of its bandwidth is not particularly limited, and may be 150 nm or even 250 nm, for example.

In this optical filter, the half-power wavelength of the second filter 130 (the wavelength at which the transmittance reaches 50%) is on the long-wavelength side relative to the half-power wavelength of the first filter 120. Absorption of light by the first filter 120 reduces the amount of light reflected by the second filter 130, and reduction of reflected light inhibits appearance of a ghost caused by reflection of light by the second filter 130.

Further similar to First Embodiment described above, the first filter 120 made of infrared absorbers (a transparent base and an infrared absorption dye) in this embodiment can make the optical filter 100 less dependent on the incident angle in the visible region (see FIG. 9) than the first filter 120 made of a dielectric multilayer. Besides, the thus configured optical filter 100 can inhibit appearance of a ghost or flare in an image taken by the imaging device.

Further in this embodiment, the optical filter 100 owes its filter characteristics in the near-infrared region to the second filter 130. To be more specific, the second filter 130 provides the optical filter 100 with the transmission characteristics on the short-wavelength side in the second band A12 and the transmission characteristics on the long-wavelength side in the second band A12. The thus configured optical filter 100 can easily change the bandwidth of the transmission band in which the transmittance is 50% or higher in the second band A12, and can flexibly meet various demands to its filter characteristics in the near-infrared region. Preferably, in the second band A12 of the optical filter 100, the bandwidth of the transmission band in which the transmittance is 50% or higher is set in a range from 35 nm to 200 nm. In this case, the wavelength band in which the transmittance in the second band A12 reaches 50% is preferably set in a range from 800 nm to 1000 nm. For example, if the bandwidth of the transmission band in the second band A12 is set to 200 nm, the second filter 130 can be configured such that the transmittance drops drastically at wavelengths around 1000 nm. As described above, the second filter 130, which can provide transmission characteristics in the second band A12 by itself, can be formed on the surface opposite to the surface of the infrared absorption dye 120b. Eventually, it is possible to prevent damage (particularly, thermal damage) to the infrared absorption dye 120b during the filter formation.

For the second filter 130 in this embodiment, similar to First Embodiment described above, the thickness ratio of the average optical thickness of the low-refractive-index layers 130L to the average optical thickness of the high-refractive-index layers 130H [the average optical thickness of the low-refractive-index layers 130L/the average optical thickness of the high-refractive-index layers 130H] is set in a range from 0.50 to 0.85. As a result, the cutoff band that has cutoff characteristics derived from the second filter 130 can be narrower, and the transmission band (the second band A12) can be set in a desired range in the near-infrared region, separately from the transmission band in the visible region.

Further in this embodiment, similar to First Embodiment described above, the bandwidth of wavelengths in which the transmittance in the first band A11 reaches 50% is greater than the bandwidth of wavelengths in which the transmittance of the first filter 120 reaches 50% and the bandwidth of wavelengths in which the transmittance of the second filter 130 reaches 50%. Hence, the transmission band (the second band A12) can be set in a desired range in the near-infrared region by means of the first and second filters 120, 130.

Further in this embodiment, the first filter 120 is composed of the transparent substrate 120a and the infrared absorption dye 120b applied thereto. By adjusting the type, concentration, thickness or other conditions for the infrared absorption dye 120b, this embodiment can achieve desired infrared absorption characteristics more easily than in the case of using the infrared-absorbing resin substrate.

Additionally, the optical filter in this embodiment owes its cutoff characteristics on the short-wavelength side in the first band A11 to the first filter 120 and the second filter 130. However, the embodiment is not limited to this configuration. The cutoff characteristics on the short-wavelength side in the first band A11 may be provided by the first filter 120 alone.

In the above description, the second filter 130 is provided on a surface of the first filter 120 not coated with the infrared absorption dye 120b, and the third filter 140 is provided on the other surface of the first filter 120 coated with the infrared absorption dye 120b. However, the embodiment is not limited to this configuration. Alternatively, the second filter 130 may be provided on a surface of the first filter 120 coated with the infrared absorption dye 120b, and the third filter 140 may be provided on the other surface of the first filter 120 not coated with infrared absorption dye 120b.

The present application claims priority to Japanese Patent Application No. 2016-169785 filed on Aug. 31, 2016. The contents of this application are incorporated herein by reference in their entirety.

### INDUSTRIAL APPLICABILITY

The present invention relates to an optical filter to be provided in an imaging device, and is applicable to an optical filter that has transmission characteristics in two wavelength bands in the visible region and the near-infrared region.

### DESCRIPTION OF REFERENCE NUMERALS

10, 100 optical filter

20, 120 first filter

30, 130 second filter

40, 140 third filter

A1, A11 first band

A2, A12 second band

A3, A13 third band

1. An optical filter having transmission characteristics in two wavelength bands in a visible region and a near-infrared region,
the optical filter comprising a first filter made of an infrared absorber, a second filter made of a dielectric multilayer and formed on a first surface of the first filter, and a third filter made of a dielectric multilayer and formed on a second surface of the first filter,
wherein the optical filter has cutoff characteristics in a first band defined from a long-wavelength side in the visible region to the near-infrared region and in a third band defined on the long-wavelength side relative to the first band, and has transmission characteristics in a second band defined between the first band and the third band, and
wherein, in the first band, a cutoff band in which a transmittance is 5% or lower is set to a bandwidth of at least 100 nm.

2. The optical filter according to claim 1,
wherein, in the first filter, a wavelength at which a transmittance of the first filter reaches 50% ranges from 640 nm to 660 nm in the visible region, and an absorption maximum is in a range from 650 nm to 800 nm, and
wherein, in the second filter, a wavelength at which a transmittance of the second filter reaches 50% ranges from 685 nm to 710 nm, and the cutoff band in which the transmittance is 5% or lower is provided in a range of at least 100 nm in the near-infrared region.

3. The optical filter according to claim 1,
wherein the wavelength at which the transmittance of the second filter reaches 50% is on a long-wavelength side relative to the wavelength at which the transmittance of the first filter reaches 50% in the visible region.

4. The optical filter according to claim 1,
wherein the first filter and the second filter provide the first band, and
wherein the third filter provides the third band.

5. The optical filter according to claim 1,
wherein the first filter provides the cutoff characteristics on a short-wavelength side in the first band,
wherein the second filter provides the transmission characteristics on a short-wavelength side in the second band, and
wherein the third filter provides the transmission characteristics on a long-wavelength side in the second band.

6. The optical filter according to claim 1,
wherein the first filter comprises a transparent substrate and an infrared absorption dye applied to the transparent substrate, and
wherein the third filter comprises an antireflective film.

7. The optical filter according to claim 6,
wherein the first filter and the second filter provide the first band, and
wherein the second filter provides the third band.

8. The optical filter according to claim 6,
wherein the first filter alone, or a combination of the first filter and the second filter, provides the cutoff characteristics on the short-wavelength side in the first band, and
wherein the second filter provides not only the transmission characteristics on the short-wavelength side in the second band but also the transmission characteristics on the long-wavelength side in the second band.

9. The optical filter according to claim 1,
wherein the transmission band in the second band in which the transmittance reaches 50% is set to a bandwidth of 35 nm to 200 nm.

10. The optical filter according to claim 9,
wherein the transmission band in which the transmittance reaches 50% in the second band is in a range from 800 nm to 1000 nm.

11. The optical filter according to claim 1,
wherein the bandwidth of the wavelength at which the transmittance in the first band reaches 50% is greater than the bandwidth of the wavelength at which the transmittance of the first filter reaches 50% and the bandwidth of the wavelength at which the transmittance of the second filter reaches 50%.

12. The optical filter according to claim 1,
wherein the second filter comprises a combination of a plurality of filters.

13. The optical filter according to claim 1,
wherein the second filter comprises a plurality of high-refractive-index layers and a plurality of low-refractive-index layers alternately laminated on each other, the low-refractive-index layers having a smaller refractive index than the high-refractive-index layers, and
wherein, in the second filter, an average optical thickness of the low-refractive-index layers is smaller than an average optical thickness of the high-refractive-index layers, and the thickness ratio of the average optical thickness of the low-refractive-index layers to the average optical thickness of the high-refractive-index layers is from 0.50 to 0.85.

14. The optical filter according to claim 2,
wherein the wavelength at which the transmittance of the second filter reaches 50% is on a long-wavelength side relative to the wavelength at which the transmittance of the first filter reaches 50% in the visible region.

15. The optical filter according to claim 2,
wherein the first filter and the second filter provide the first band, and
wherein the third filter provides the third band.
